(19) United States
(12) Patent Application Publication
(10) Pub. No.: US 2011/0277910 A1
(43) Pub. Date: Nov. 17, 2011

(54) Methods for Making Elastic Laminate

(76) Inventors: Ko-Feng Wang, Fengshan (TW); I-Peng Yao, Sanmin (TW); Kun-Lin Chiang, Ziguan (TW)

(21) Appl. No.: 13/186,680

(22) Filed: Jul. 20, 2011

Related U.S. Application Data
(62) Division of application No. 12/060,923, filed on Apr. 2, 2008.
Application No. 12/060,923 is a continuation-in-part of application No. 11/270,436, filed on Nov. 9, 2005, now abandoned.
Application No. 11/270,436 is a continuation-in-part of application No. 11/199,437, filed on Aug. 8, 2005, now abandoned.

(51) Int. Cl. B32B 37/12

(52) U.S. Cl. 156/77

(57) ABSTRACT

A method for making an elastic laminate includes providing adhesive on each of two sides of a highly porous foil to form a polygonal reticulate adhesive film which includes a plurality of polygonal adhesive dots spaced from one another by a plurality of adhesive-free linear gaps, or which includes a plurality of hollow polygonal adhesive units connected to one another and each encloses a polygonal adhesive-free gap. Two sheets of elastic layers are adhered by the adhesive to the sides of the highly porous foil so that polygonal reticulate gaps exist between the highly porous foil and the elastic layer, providing a laminate with moisture-absorbing, permeable, quick drying, thermally insulating, and elastic properties.

### CROSS REFERENCE TO RELATED APPLICATION

This is a divisional application of U.S. patent application Ser. No. 12/060,923 filed Apr. 2, 2008, which is a continuation-in-part application of U.S. patent application Ser. No. 11/270,436 filed Nov. 9, 2005, which is a continuation-in-part application of U.S. patent application Ser. No. 11/199,437 filed Aug. 8, 2005.

### BACKGROUND OF INVENTION

The present invention relates to methods for making an elastic laminate and, more particularly, to methods for making a moisture-absorbing, quick drying, thermally insulating, elastic laminate for use in clothes and footgear.

Conventional laminates for use in clothes and footgear are dense. Such a laminate includes layers that are not highly porous. The layers are adhered to one another by using adhesive that forms a continuous film between any adjacent two thereof. The adhesive film does not provide sufficient pores for passing moisture between any adjacent two of the layers nor enough space for retaining air, and is not highly permeable nor thermally insulating. In addition, limited by the layers of the laminates, the laminates fail to provide elasticity.

FIGS. 1 and 2 show an elastic and permeable laminate 10 disclosed in Taiwanese Patent Publication No. 532282. The laminate 10 includes a fabric layer 11 and an elastic layer 12. The fabric layer 11 is made of micro fibers and can be non-woven fabric or ordinary fabric. The fabric layer 11 includes a substrate 111 made with a pre-determined shape and laces 112 bonded to the substrate 111. The laces 112 can be fibers or yarns. The elastic layer 12 is made from a closed-pore foam material with pre-determined thickness. The foam material can be plastic or rubber such as ethylene-vinyl acetate copolymer (“EVA”), polyethylene (“PE”), polyurethane (“PU”), nitrile-butadiene rubber (“NBR”) and styrene-butadiene rubber (“SBR”). The elastic layer 12 includes a lower surface 121 facing the fabric layer 11 and an upper surface 122 opposite to the lower surface 121. Apertures 123 are made by needling in the elastic layer 12 from the top 122 to the bottom 121, and the laces 112 are pulled through the apertures 123 in order to firmly bind the fabric layer 11 to the elastic layer 12. The apertures 123 provide permeability. Thus, the laminate 10 is elastic and air-permeable. The laces 112 exposed from the elastic layer 12 provide the feel and look of fabric. However, the apertures 123 are aesthetically unpleasant. Moreover, the laminate 10 exhibits poor permeability regarding moisture.

U.S. Pat. No. 6,451,404 entitled “Leather-like sheet having napped surface” discloses a leather-like sheet including a first nonwoven fabric, a second nonwoven fabric, a moisture permeable film layer, an adhesive layer, and a fluff layer. The adhesive layer was in the form of a discontinuous layer of adhesive having dots therein to attain high-class hand touch, feel and external appearance. However, this patent does not disclose or teach control of the adhesive application ratio by changing distribution patterns of the “dots” or “lines”.

Several problems exist when applying a discontinuous layer of adhesive to a laminate (or a leather-like sheet). For example, the bonding strength is low if the application rate of the adhesive between two adjacent layers of a laminate is low. The resultant laminate has excellent permeability to air and liquid; but it is liable to peel off and is not waterproof. On the other hand, if the application rate of the adhesive between two adjacent layers of the laminate is high, the resultant laminate has excellent bonding strength at the cost of poor permeability. FIG. 3 shows application of adhesive in circular dots. A plurality of wide gaps 32 exist between the circular dots 31 such that the overall adhesive-free area is large, leading to the risks of high permeability, poor waterproof structure, and low peel strength. A further problem of the discontinuous layer of adhesive in FIG. 3 is that the circular adhesive dots are difficult to adhere to a face of a substrate of a laminate regardless of whether the substrate is made of fabric or non-fabric, leading to poor peel strength of the laminate.

The present invention is therefore intended to obviate or at least alleviate the problems encountered in the prior art.

### SUMMARY OF INVENTION

According to an aspect of the present invention, a method includes using a foil with a low density and a high porosity as a substrate. A first adhesive is applied to a first side of the foil and forms a first polygonal reticulate film. A first elastic layer is adhered to the first side of the foil by the first adhesive so that polygonal reticulate gaps exist between the first elastic layer and the foil of the laminate.

Preferably, a second adhesive is applied to a second side of the foil and forms a second polygonal reticulate film. A second elastic layer is adhered to the second side of the foil by the second adhesive so that polygonal reticulate gaps exist between the second elastic layer and the foil of the laminate.

Preferably, the foil is made of at least one material selected from a group consisting of polyurethane, polyolefin, ethylene-vinyl acetate copolymer (“EVA”), polyethylene terephthalate, polyamide and polyester.

Preferably, the foil includes continuous pores and the porosity is 60% to 90%.

Preferably, the foil includes a density of 0.1 to 0.3 g/cm³.

Preferably, the foil includes a thickness of 0.1 to 1.0 mm.

Preferably, the elastic layer is made of at least one material selected from a group consisting of nylon, polyester, protein, cotton, rayon and polyurethane.

In a preferred teaching, the first adhesive includes a plurality of polygonal adhesive dots spaced from one another by a plurality of adhesive-free linear gaps to form the first polygonal reticulate film, and the second adhesive includes a plurality of polygonal adhesive dots spaced from one another by a plurality of adhesive-free linear gaps to form the second polygonal reticulate film. Preferably, the polygonal adhesive dots cover 10% to 95% of the sides of the foil, and more preferably 30% to 60%. Preferably, the polygonal adhesive dots include a plurality of triangular adhesive dots or quadrangular adhesive dots, and more preferably the polygonal adhesive dots are made of a plurality of hexagonal adhesive dots. Preferably, the adhesive-free linear gaps are honeycombed with a plurality of hexagonal gaps.

In another preferred teaching, the first adhesive includes a plurality of hollow polygonal adhesive units connected to one another to form the first polygonal reticulate film, and the second adhesive includes a plurality of hollow polygonal adhesive units connected to one another to form the second polygonal reticulate film. Preferably, the hollow polygonal adhesive units cover 10% to 95% of the sides of the foil, and more preferably 30% to 60%. Preferably, each hollow polygonal adhesive unit encloses a triangular adhesive-free gap or quadrangular adhesive-free gap, and more preferably each hollow polygonal adhesive unit includes a hexagonal adhesive-free gap. Preferably, the hollow polygonal adhesive units are honeycombed with a plurality of hexagonal adhesive units.

Other objectives, advantages and novel features of the invention will become more apparent from the following detailed description in conjunction with the drawings.

### BRIEF DESCRIPTION OF DRAWINGS

The present invention will be described through detailed illustration of the preferred teachings referring to the drawings.

FIG. 1 is an exploded view of a laminate disclosed in Taiwanese Patent Publication No. 532282.

FIG. 2 is a cross-sectional view of the laminate shown in FIG. 1 after bonding.

FIG. 3 is a diagrammatic view of application of adhesive in circular dots.

FIG. 4 is a cross-sectional view of an elastic laminate according to the preferred teachings of the present invention.

FIG. 5 is a diagrammatic view of application of adhesive in triangular reticulate dots according to the preferred teachings of the present invention.

FIG. 6 is a diagrammatic view of application of adhesive in quadrangular reticulate dots according to the preferred teachings of the present invention.

FIG. 7 is a diagrammatic view of application of adhesive in hexagonal reticulate dots according to the preferred teachings of the present invention.

FIG. 8 is a diagrammatic view of application of adhesive in triangular reticulate lines according to the preferred teachings of the present invention.

FIG. 9 is a diagrammatic view of application of adhesive in quadrangular reticulate lines according to the preferred teachings of the present invention.

FIG. 10 is a diagrammatic view of application of adhesive in hexagonal reticulate lines according to the preferred teachings of the present invention.

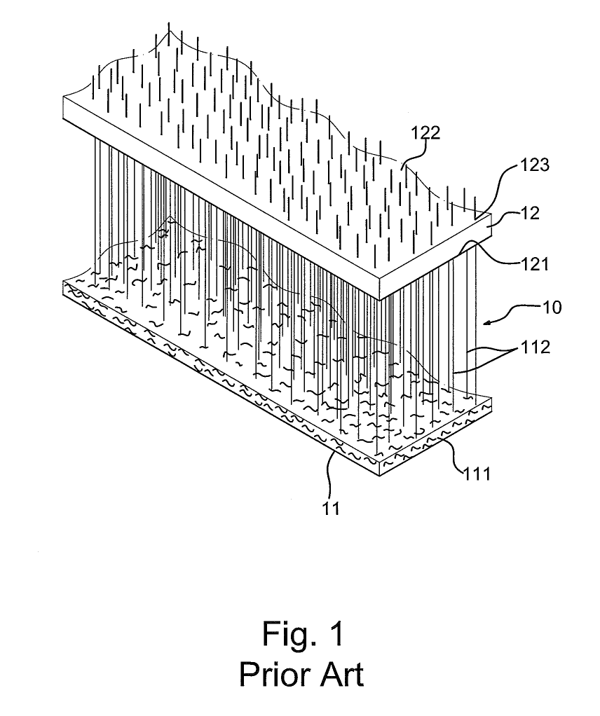

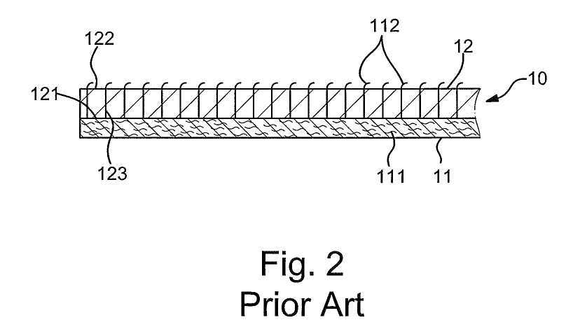

### DETAILED DESCRIPTION OF PREFERRED TEACHINGS

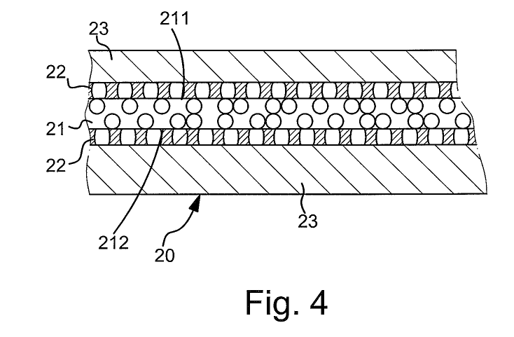

According to the preferred teachings of the present invention, a method for making an elastic laminate is provided. Firstly, referring to FIG. 4, a foil 21 having opposite first and second sides 211, 212 is made from polyurethane (PU) with a density of 0.2 g/cm³ and a porosity rate of 80%. The foil 21 is put on a workbench. Then, a first adhesive 22 is applied to the first side 211 of the foil 21 with the first adhesive 22 forming a polygonal reticulate film and covering over 30% of the first side 211 of the foil 21. Then, a first elastic layer 23 is adhered to the first side 211 of the foil 21 by the first adhesive 22. After the first adhesive 22 cures, the foil 21 is inversed and put back onto the workbench. A second adhesive 22 is applied to the second side 212 of the foil 21 with the second adhesive 22 forming a polygonal reticulate film and covering over 30% of the second side 212 of the foil 21. Then, a second elastic layer 23 is adhered to the second side 212 of the foil 21 by the second adhesive 22 of the polygonal reticulate film to form the elastic laminate 20.

The density of the foil 21 is 0.2 g/cm³, and the porosity rate of the foil is 80% so that the laminate 20 provides a lot of space for absorbing fluid (such as sweat and air) from the exterior. The high porosity of the foil 21 renders the laminate 20 high in extensibility, highly moisture-absorbing, quick drying, thermally insulating, and elastic. Further, since the adhesive 22 of a polygonal reticulate film is provided between each elastic layer 23 and the foil 21, the laminate 20 has excellent peel strength and waterproof properties.

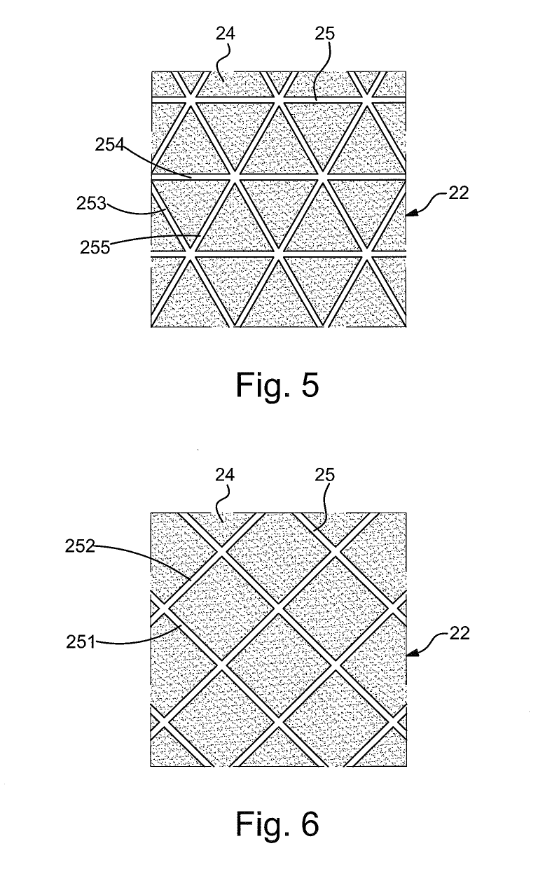

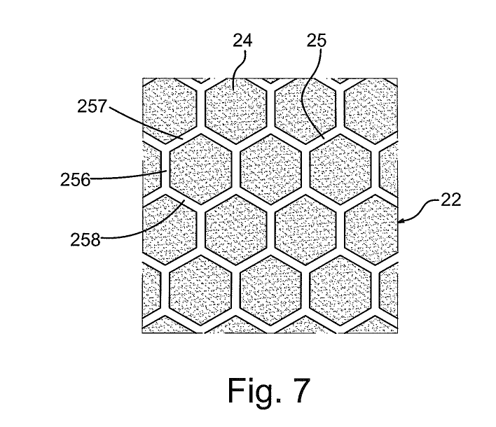

Referring to FIGS. 5 to 7, there are shown various cross sections of the adhesive 22 of the polygonal reticulate film of different embodiments according to the preferred teachings of the present invention. Each adhesive 22 in FIGS. 5 to 7 respectively forms a polygonal reticulation and includes a plurality of polygonal adhesive dots 24 spaced from one another by a plurality of adhesive-free linear gaps 25. The polygonal adhesive dots 24 can be triangular as shown in FIG. 5 or quadrangular as shown in FIG. 6 or hexagonal as shown in FIG. 7.

The adhesive-free linear gaps 25 shown in FIG. 5 include a plurality of first, parallel, continuous adhesive-free lines 253, a plurality of second, parallel, continuous adhesive-free lines 254 at an acute angle with the plurality of first, parallel, continuous adhesive-free lines 253, and a plurality of third, parallel, continuous adhesive-free lines 255 at an acute angle with both the plurality of first, parallel, continuous adhesive-free lines 253 and the plurality of second, parallel, continuous adhesive-free lines 254 to form a plurality of triangular adhesive dots 24 between the plurality of first, parallel, continuous adhesive-free lines 253, the plurality of second, parallel, continuous adhesive-free lines 254 and the plurality of third, parallel, continuous adhesive-free lines 255. Each triangular adhesive dot 24 is surrounded with a segment of one of the first adhesive-free lines 253, a segment of one of the second adhesive-free lines 254, and a segment of one of the third adhesive-free lines 255. The area ratio of the triangular adhesive dots 24 is easily controlled by change of the thickness of the adhesive-free lines 253, 254, and 255, thus allowing easy control of waterproof properties. Specifically, if the thickness of the adhesive-free lines 253, 254, and 255 is decreased, the laminate 20 has excellent peel strength and waterproof properties.

The adhesive-free linear gaps 25 shown in FIG. 6 include a plurality of first, parallel, continuous adhesive-free lines 251 and a plurality of second, parallel, continuous adhesive-free lines 252 transverse to the plurality of first, parallel, continuous adhesive-free lines 251, forming a plurality of quadrangular adhesive dots 24 between the plurality of first, parallel, continuous adhesive-free lines 251 and the plurality of second, parallel, continuous adhesive-free lines 252. Each quadrangular adhesive dot 24 is surrounded with two adjacent first adhesive-free segments of lines 251 and two adjacent second adhesive-free segments of lines 252. The area ratio of the quadrangular adhesive dots 24 is easily controlled by change of the thickness of the adhesive-free lines 251, 252, thus allowing easy control of waterproof properties. Specifically, if the thickness of the adhesive-free lines 251, 252 is decreased, the laminate 20 has excellent peel strength and waterproof properties.

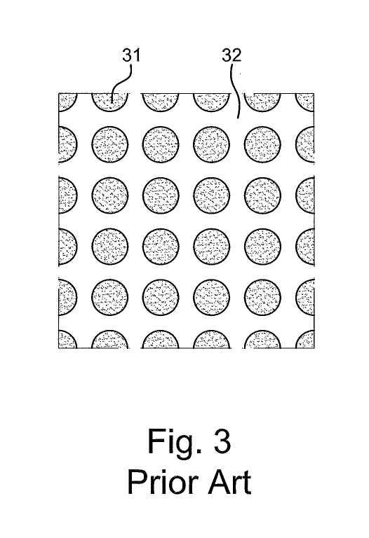

The adhesive-free linear gaps 25 shown in FIG. 7 are honeycombed with a plurality of hexagonal gaps which are connected to one another and each of which includes a pair of first, parallel adhesive-free segment of lines 256, a pair of second, parallel adhesive-free segment of lines 257 at an obtuse angle with the pair of first, parallel adhesive-free segment of lines 256, and a pair of third, parallel adhesive-free segment of lines 258 at an angle with both the pair of first, parallel adhesive-free segment of lines 256 and the pair of second, parallel adhesive-free segment of lines 257 to form a hexagonal adhesive dot 24 between the pair of first, parallel adhesive-free segment of lines 256, the pair of second, parallel adhesive-free segment of lines 257 and the pair of third, parallel adhesive-free segment of lines 258. The hexagonal adhesive dots 24 effectively provide higher peel strength than laminate bonded by adhesive in the form of circular dots shown FIG. 3. Furthermore, if the thickness of the adhesive-free segment of lines 256, 257, and 258 is decreased, the laminate 20 has excellent peel strength and waterproof properties.

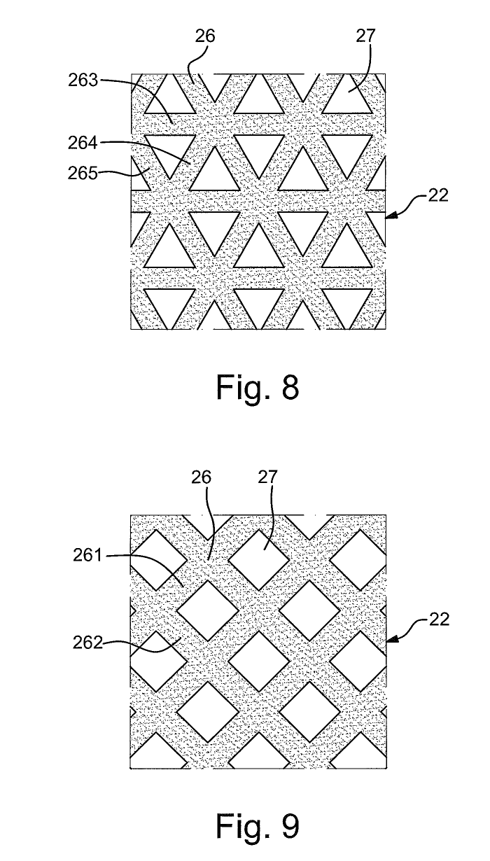

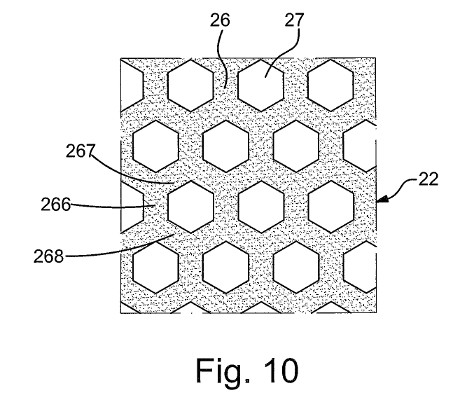

Referring to FIGS. 8 to 10, there are shown various cross sections of the adhesive 22 of the polygonal reticulate film of different embodiments according to the preferred teachings of the present invention. Each adhesive 22 in FIGS. 8 to 10 respectively forms a polygonal reticulation and includes a plurality of hollow polygonal adhesive units 26 connected to one another. Each hollow polygonal adhesive unit 26 encloses a polygonal adhesive-free gap 27 which can be triangular as shown in FIG. 8 or quadrangular as shown in FIG. 9 or hexagonal as shown in FIG. 10.

The hollow polygonal adhesive units 26 shown FIG. 8 include a plurality of first, parallel, continuous adhesive lines 263, a plurality of second, parallel, continuous adhesive lines 264 at an acute angle with the plurality of first, parallel, continuous adhesive lines 263, and a plurality of third, parallel, continuous adhesive lines 265 at an acute angle with both the plurality of first, parallel, continuous adhesive lines 263 and the plurality of second, parallel, continuous adhesive lines 264 to form a plurality of triangular adhesive-free gaps 27 between the plurality of first, parallel, continuous adhesive lines 263, the plurality of second, parallel, continuous adhesive lines 264 and the plurality of third, parallel, continuous adhesive lines 265. The adhesive lines 263, 264, and 265 are continuous and, thus, provide higher peel strength than laminate bonded by adhesive in the form of circular dots shown FIG. 3. Specifically, if the thickness of the adhesive lines 263, 264, and 265 is increased, the laminate 20 has excellent peel strength and waterproof properties.

The hollow polygonal adhesive units 26 shown in FIG. 9 include a plurality of first, parallel, continuous adhesive lines 261 and a plurality of second, parallel, continuous adhesive lines 262 transverse to the plurality of first, parallel, continuous adhesive lines 261, forming a plurality of quadrangular adhesive-free gaps 27 between the plurality of first, parallel, continuous adhesive lines 261 and the plurality of second, parallel, continuous adhesive lines 262. The adhesive lines 261, 262 are continuous and, thus, provide higher peel strength than laminate bonded by adhesive in the form of circular dots shown FIG. 3. Specifically, if the thickness of the adhesive lines 261, 262 is increased, the laminate 20 has excellent peel strength and waterproof properties.

The hollow polygonal adhesive units 26 shown in FIG. 10 are honeycombed with a plurality of hexagonal adhesive units 26 each of which includes a pair of first, parallel adhesive segment of lines 266, a pair of second, parallel adhesive segment of lines 267 at an angle with the pair of first, parallel adhesive segment of lines 266, and a pair of third, parallel adhesive segment of lines 268 at an angle with both the pair of first, parallel adhesive segment of lines 266 and the pair of second, parallel adhesive segment of lines 267 to form a hexagonal adhesive-free gap 27 between the pair of first, parallel adhesive segment of lines 266, the pair of second, parallel adhesive segment of lines 267 and the pair of third, parallel adhesive segment of lines 268. The adhesive 22 in the form of honeycomb reticulation is continuous and, thus, provide higher peel strength than laminate bonded by adhesive in the form of circular dots shown FIG. 3. Specifically, if the thickness of the adhesive segment of lines 266, 267, and 268 is increased, the laminate 20 has excellent peel strength and waterproof properties.

The laminate 20 according to the preferred teachings of the present invention is rendered permeable, elastic, and high in peel strength because of the forming of the adhesive 22 of the polygonal reticulate film between each of the elastic layers 23 and the foil 21 of the laminate 20. Moreover, the waterproof properties of the laminate 20 can be easily controlled through control of the polygonal reticulate adhesive 22 application ratio. Furthermore, a further advantage of the continuous polygonal reticulate adhesive 22 is to facilitate the same to adhere to the sides 211, 212 of the foil 21 of the laminate 20 regardless of whether the foil 21 is made of fabric or non-fabric, leading to high peel strength of the laminate 20.

The present invention has been described through the detailed illustration of the preferred teachings. Those skilled in the art can derive variations from the preferred teachings without departing from the scope of the present invention. Therefore, the preferred teachings shall not limit the scope of the present invention defined in the claims.

What is claimed is:

1. A method for making an elastic laminate, comprising:
providing a foil with a low density and a high porosity, with the foil having opposite first and second sides;
applying a first adhesive to the first side of the foil, with the first adhesive forming a polygonal reticulate film; and
adhering a first elastic layer to the first side of the foil by the first adhesive.

2. The method according to claim 1 further comprising:
applying a second adhesive to the second side of the foil after adhering the first elastic layer to the first side of the foil, with the second adhesive forming a second polygonal reticulate film; and
adhering a second elastic layer to the second side of the foil by the second adhesive.

3. The method according to claim 1, wherein providing the foil includes providing the foil made of at least one material selected from a group consisting of polyurethane, polyolefin, ethylene-vinyl acetate copolymer, polyethylene terephthalate, polyamide and polyester, and wherein adhering the first elastic layer to the first side of the foil includes adhering the first elastic layer made of at least one material selected from a group consisting of nylon, polyester, protein, cotton, rayon and polyurethane to the first side of the foil.

4. The method according to claim 3, wherein applying the first adhesive to the first side of the foil includes applying the first adhesive having a plurality of polygonal adhesive dots defined by a plurality of adhesive-free linear gaps to the first side of the foil.

5. The method according to claim 4, wherein applying the first adhesive having the plurality of polygonal adhesive dots includes applying the first adhesive having the plurality of polygonal adhesive dots covering 30% to 60% of the first side of the foil.

6. The method according to claim 4, wherein applying the first adhesive having the plurality of polygonal adhesive dots includes applying the first adhesive having a plurality of polygonal adhesive dots each of which is triangular, quadrangular, or hexagonal.

7. The method according to claim 4, wherein applying the first adhesive defined by the adhesive-free linear gaps includes applying the first adhesive defined by the adhesive-free linear gaps being honeycombed with a plurality of hexagonal gaps.

8. The method according to claim 3, wherein applying the first adhesive includes applying the first adhesive having a plurality of hollow polygonal adhesive units connected to one another, with each hollow polygonal adhesive unit enclosing a polygonal adhesive-free gap.

9. The method according to claim 8, wherein applying the first adhesive having the plurality of hollow polygonal adhesive units includes applying the first adhesive having the plurality of hollow polygonal adhesive units covering 30% to 60% of the first side of the foil.

10. The method according to claim 8, wherein applying the first adhesive having the plurality of hollow polygonal adhesive units includes applying the first adhesive having a plurality of hollow polygonal adhesive units each of which is triangular, quadrangular, or hexagonal.

11. The method according to claim 8, wherein applying the first adhesive having the plurality of hollow polygonal adhesive units includes applying the first adhesive having a plurality of hollow polygonal adhesive units being honeycombed with a plurality of hexagonal adhesive units each of which includes a pair of first, parallel adhesive segment of lines, a pair of second, parallel adhesive segment of lines at an angle with the pair of first, parallel adhesive segment of lines, and a pair of third, parallel adhesive segment of lines at an angle with both the pair of first, parallel adhesive segment of lines and the pair of second, parallel adhesive segment of lines to form a hexagonal adhesive-free gap between the pair of first, parallel adhesive segment of lines, the pair of second, parallel adhesive segment of lines and the pair of third, parallel adhesive segment of lines.

12. The method according to claim 8, wherein applying the first adhesive having the plurality of hollow polygonal adhesive units includes applying the first adhesive having a plurality of hollow polygonal adhesive units being distributed by including a plurality of first, parallel, continuous adhesive lines and a plurality of second, parallel, continuous adhesive lines transverse to the plurality of first, parallel, continuous adhesive lines, forming a plurality of adhesive-free quadrangles between the plurality of first, parallel, continuous adhesive lines and the plurality of second, parallel, continuous adhesive lines.

13. The method according to claim 8, wherein applying the first adhesive having the plurality of hollow polygonal adhesive units includes applying the first adhesive having a plurality of hollow polygonal adhesive units being distributed by including a plurality of first, parallel, continuous adhesive lines, a plurality of second, parallel, continuous adhesive lines at an acute angle with the plurality of first, parallel, continuous adhesive lines, and a plurality of third, parallel, continuous adhesive lines at an acute angle with both the plurality of first, parallel, continuous adhesive lines and the plurality of second, parallel, continuous adhesive lines to form a plurality of adhesive-free triangles between the plurality of first, parallel, continuous adhesive lines, the plurality of second, parallel, continuous adhesive lines and the plurality of third, parallel, continuous adhesive lines.
